(19) United States
(12) Patent Application Publication
(10) Pub. No.: US 2021/0334658 A1
(43) Pub. Date: Oct. 28, 2021

(54) METHOD FOR PERFORMING CLUSTERING ON POWER SYSTEM OPERATION MODES BASED ON SPARSE AUTOENCODER

(71) Applicants: XI'AN JIAOTONG UNIVERSITY, Xi'an (CN); STATE GRID JIANGSU ELECTRIC POWER CO., LTD., Nanjing (CN)

(72) Inventors: Gengfeng LI, Xi'an (CN); Yuxiao LEI, Xi'an (CN); Chunlei XU, Nanjing (CN); Xiaohu ZHANG, Beijing (CN); Di SHI, Beijing (CN); Jiangfeng JIANG, Xi'an (CN); Yuxiong HUANG, Xi'an (CN); Yuming PENG, Xi'an (CN); Zhaohong BIE, Xi'an (CN)

(21) Appl. No.: 17/368,864

(22) Filed: Jul. 7, 2021

Related U.S. Application Data
(63) Continuation of application No. PCT/CN2019/108714, filed on Sep. 27, 2019.

(30) Foreign Application Priority Data
Jan. 8, 2019 (CN) 201910016263.4

(51) Int. Cl. G06N 3/08; G05B 19/042

(52) U.S. Cl. CPC G06N 3/08; G05B 2219/2639; G05B 19/042

(57) ABSTRACT

The present disclosure provides a method for performing clustering on operation modes of a power system based on a sparse autoencoder. The method includes: obtaining related data of the power system; setting a training parameter, a number of hidden layers, and a number of neurons; training an autoencoder model using the related data and extracting a topological structure and a weight matrix from the model; performing cluster analysis to obtain a number of typical scenarios; and performing decoding to obtain original data at centers of respective scenarios. The present disclosure can achieve fast selection and dimensionality reduction of feature vectors representing operation modes of a power system. In view of this, the present disclosure provides a novel idea and method for selecting a feature vector representing an operation mode of a power system and generating a typical operation scenario.

### CROSS-REFERENCE TO RELATED APPLICATIONS

The present application is a continuation of International Application No. PCT/CN2019/108714, filed on Sep. 27, 2019, which claims priority to Chinese Patent Application No. 201910016263.4, filed on Jan. 8, 2019, both of which are hereby incorporated by reference in their entireties.

### TECHNICAL FIELD

The present disclosure relates to the field of safety verification and planning operation technologies for a power system, and more specifically, to a method for performing clustering on operation modes of a power system based on a sparse autoencoder.

### BACKGROUND

Typical operation modes used in a power system play a critical role in verifying safe operations of a power grid. In the planning period, considering the typical operation modes and performing operation verifications of the power system with the typical operation modes may prevent accidents such as voltage violations and overload to the greatest extent, thereby ensuring the continuous power supply capacity of the power system to the load and users. However, with the continuous introduction of new energy sources, the randomness of the operation of the power system has greatly increased, resulting in the more complex features of the operation modes. Accordingly, how to extract a feature vector of an operation mode to generate a typical scenario becomes particularly difficult. However, with the conventional PCA method, the feature vector cannot be accurately extracted, leading to the high time complexity while greatly lowering the practicality.

Therefore, in order to ensure a reliable extraction of a feature vector representing an operation mode of a power system for analysis of typical scenarios, it is needed to select a reasonable feature vector extraction method.

In view of the above-mentioned problems, the present disclosure proposes a method for extracting a feature vector representing an operation mode of a power system using a sparse autoencoder.

### SUMMARY

The present disclosure is to provide a method for performing clustering on operation modes of a power system based on a sparse autoencoder, aiming to overcome the above defects in the related art.

The present disclosure adopts the following technical solutions.

The present disclosure provides a method for performing clustering on operation modes of a power system based on a sparse autoencoder. The method includes: obtaining related data of the power system; setting a training parameter, a number of hidden layers, and a number of neurons; training an autoencoder model using the related data and extracting a topological structure and a weight matrix from the model; performing cluster analysis to obtain a number of typical scenarios; and performing decoding to obtain original data at centers of respective scenarios.

Further, the related data forms an input matrix Xₙ^{m} having n rows and m columns, n being a vector, and m being a number of samples.

Further, the related data includes a voltage of each node in the power system, a voltage amplitude, data of active power and reactive power of an electric generator at each node, and time-series load data of the power system within research time.

Further, said setting the training parameter, the number of hidden layers, and the number of neurons includes: setting related parameters α, η, and a maximum number of iterations as initialization training parameters, a being a coefficient of L2 regularization, and η being a coefficient of sparse regularization; setting l=1, l being the number of hidden layers; and setting hₗ=2, hₗ being the number of neurons of an l-th hidden layer, which is a dimension of a final feature vector.

Further, said training the autoencoder model using the related data includes steps of: S201 of determining an input matrix Xₙ^{m} having n rows and m columns formed by the related data as an input; S202 of inputting an acceptable error e and a training time t for visual training, and observing the error and a training process; S203 of extracting a lowest-layer feature vector featuresₗ, and performing the cluster analysis on featuresₗ; S204 of finding k types of centers of scenarios, and decoding the k types of centers of scenarios to restore centers of the original data of the typical scenarios and restore all of the original data \hat{X}ₙ; and S205 of obtaining a desired result, and ending a cycle.

Further, in step S202, in response to a Euclidean distance between restored input data and original input data being greater than e, a number of iterations is increased, and the model is retrained; and in response to training time of the model being longer than t, that is, in response to the error reaching a range in an early iteration, the number of iterations is decreased, and the model is retrained.

Further, in step S203, K-means method is selected for the clustering, a number of cluster centers is set as k, an initial value is set as k=1, and a Silhouette value Silₖ^{h} is calculated; the Silhouette value Silₖ^{h} is calculated by taking k=k+1, and in response to k=h, the cycle exits; and a maximum Silhouette value Silₖ^{h} and a number k of the typical scenarios are obtained.

Further, in response to the maximum Silhouette value Silₖ^{h} being smaller than 0.85, the number of neurons is reset when hₗ<hₗ₋₁, and the model is retrained when hₗ=hₗ₊₁; otherwise, the number of hidden layers is reset as l=l+1, and the model is retrained.

Further, in step S204, a Euclidean distance Φ_{d} between the matrix Xₙ^{m} and \hat{X}ₙ is calculated, and an acceptance is made in response to Φ_{d}≤ε.

Further, in step S204, in response to Φ_{d}>ε and l>1, the model is retrained by returning to l=l−1; otherwise, the model is retrained by returning to h=h−1.

Compared with the related art, the present disclosure at least has the following beneficial effects.

With the method for performing clustering on operation modes of a power system based on a sparse autoencoder according to the present disclosure, the sparse autoencoder technology is applied to the selection of a feature vector of the power system. In this manner, correlations among inputs may be found by training the model, without complex and cumbersome manual data standardization processes. Moreover, the dimensionality of the feature vector can be reduced, the initial number of scenarios of the clustering can be determined, and the complexity of clustering time can be significantly reduced.

Further, since the related data reflects main features on the operation of the power system, using the related data as an input can increase a speed and an accuracy of the Sparse Autoencoder training model.

Further, the initial training parameters, the number of hidden layers and the number of neurons may be flexibly set based on requirements of clustering accuracy of different power system models, thereby facilitating training in different situations.

Further, by training the autoencoder model, the accuracy of the model may be improved, so that the feature vector can be accurately extracted, thereby providing satisfying conditions for the cluster analysis.

Further, with the lowest-layer feature vector features obtained by training the autoencoder model, the Silhouette value of scenario clustering is obtained for determining pros and cons of the model and modifying the model.

Further, the lowest-layer feature vector features obtained after training is restored and compared with an input vector to determine a restoration degree and an error of the model. The model may be used if requirements are satisfied.

Further, the lowest-layer feature vector features obtained by the training is restored and compared with the input vector. If the error is too large, parameters are modified to retrain the model.

In summary, the present disclosure can achieve fast selection and dimensionality reduction of feature vectors representing operation modes of a power system. In view of this, the present disclosure provides a novel idea and method for selecting a feature vector representing an operation mode of a power system and generating a typical operation scenario. The present disclosure is useful in a novel application for neural networks.

The technical solutions of the present disclosure will be further described in detail below in combination with the accompanying drawings and embodiments.

### BRIEF DESCRIPTION OF DRAWINGS

FIG. 1 is a flowchart of a process of a sparse autoencoder.

FIG. 2 is a schematic diagram simply illustrating an algorithm of a sparse autoencoder.

### DESCRIPTION OF EMBODIMENTS

The Sparse Autoencoder technology may avoid complex data standardization for a power system, and trained feature vectors for cluster analysis have small errors and may better restore original data of the power system after being decoded. Thus, the technology is selected due to the above excellent characteristics.

Sparse Autoencoder is an unsupervised learning algorithm, which uses a backpropagation algorithm and makes a target value equal to an input value. Taking y⁽ⁱ⁾=x⁽ⁱ⁾ as an example, a neural network tries to learn a function of h_{w,b}(x)≈x. When a reduction in the number of neurons can force the neural network to learn a compressed representation of input data, a dimensionality reduction process of data is achieved. In addition, since such an algorithm is conducive to discovering correlations in the input data, the algorithm is more suitable for a power system.

A. Definition of Sparsity:

An average output activation measure of a neuron is defined as:

$${\hat{ρ}}_{j} = \frac{1}{m} {\sum }_{i = 1}^{m} [ {a}_{j}^{( 1 )} ( {x}^{( 1 )} ) ] ,$$

where aⱼ⁽ⁱ⁾ denotes an activation degree of a hidden neuron j and is used to represent the activation degree of the hidden neuron j in an auto-encoding neural network with a given input x. In addition, in order to increase the sparsity of the model, a sparsity constraint is added and expressed as:

\hat{ρ}ⱼ=ρ

where ρ denotes a sparsity parameter, which is usually a small value close to 0 (for example, ρ=0.03). In order to achieve such constraint, an additional penalty factor will be added to an optimized objective function. The penalty factor will punish cases where \hat{ρ}ⱼ is significantly different from ρ, in such a manner that an average activation degree of the hidden neuron keeps at a relatively low level. There are many reasonable choices for the specific form of the penalty factor, and the following form is selected:

$${Φ}_{sparsity} = {\sum }_{j = 1}^{{s}_{1}} ρ log \frac{ρ}{{\hat{ρ}}_{j}} + ( 1 - ρ ) log \frac{1 - ρ}{1 - {\hat{ρ}}_{j}} .$$

In the equation, s₁ denotes a number of hidden neurons in a hidden layer, and an index j denotes each neuron in the hidden layer in turn.

B. L2 Regularization:

Regularization is an important means to prevent overfitting in machine learning, because an actual model may not be that complicated, and a learned model topology and a learned weight matrix may only perform well on training data. Overfitting may occur for many features but few samples. Consequently, it is needed to transform the model into a simpler model.

The present disclosure uses L2 regularization.

A formula is defined as follows:

$${Φ}_{weights} = \frac{1}{2} {\sum }_{l}^{L} {\sum }_{j}^{n} {{\sum }_{i}}^{k} {( {w}_{ji}^{( l )} )}^{2} ,$$

where L denotes a number of hidden layers, n denotes a number of observations, and k denotes a number of variables in a training set.

C. Cost Function:

$${E}_{cost} = \frac{1}{N} {\sum }_{n = 1}^{N} {\sum }_{k = 1}^{K} {( {x}_{kn} - {{x}^{Λ}}_{kn} )}^{2} + {α}^{*} {Φ}_{weights} + {η}^{*} {Φ}_{sparsity} ,$$

where α denotes a coefficient of L2 regularization, and η denotes a coefficient of sparse regularization, both of which may be modified by means of L2WeightRegularization function and SparsityRegularization function, respectively.

The present disclosure provides a method for performing clustering on operation modes of a power system based on a sparse autoencoder. The method includes: obtaining related data of the power system, e.g., a voltage of each node in the power system, a voltage amplitude, a load at each node, and an active power output and a reactive power output of an electric generator; setting a training parameter, a number of hidden layers, and a number of neurons; training a related model and extracting a topological structure and a weight matrix from the model; performing cluster analysis to obtain a number of typical scenarios; and performing decoding to obtain original data at centers of respective scenarios. The method according to the present disclosure enables fast selection and dimensionality reduction to be performed on feature vectors representing operation modes of the power system. The present disclosure provides a novel idea and method for fast selection of a feature vector representing an operation mode of a power system and generation of a typical operation scenario.

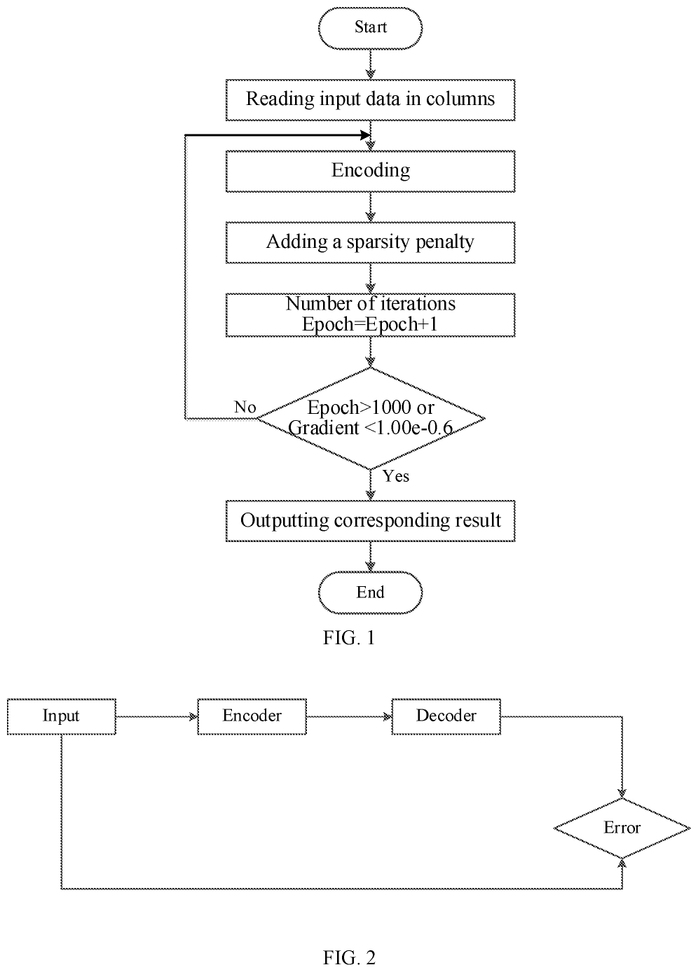

Referring to FIGS. 1 and 2, the method for performing clustering on operation modes of a power system based on a sparse autoencoder includes steps as follows.

At step S1, a simple initialization is performed on data.

A rough screening of power system operations is performed on data. For example, a voltage of each node in the power system, data of active power and reactive power of an electric generator at each node, and time-series load data of the power system within research time are obtained. These data may form n dimensions, i.e., n rows of vectors, and a number of samples is m, thereby forming an input matrix having n rows and m columns, which is recorded as Xₙ^{m}.

At step S2, an autoencoder model is trained using a data matrix obtained in step S1. A lowest-layer feature vector is extracted for clustering to determine a number of typical scenarios. All data \hat{X}ₙ is decoded and restored.

Related parameters α, η, and a maximum number of iterations are set. α is a coefficient of L2 regularization, and η is a coefficient of sparse regularization, both of which are initialization training parameters. The number of neurons of an l-th hidden layer, i.e., a dimension of a final feature vector, is recorded as hₗ=2. The number of hidden layers is set as a default value one and is recorded as l=1.

At step S201, Xₙ^{m} is determined as an input for training the autoencoder model in MATLAB.

At step S202, a training process is visualized to observe an error and the training process. An acceptable error e and a training time t are inputted for visual training. In response to a Euclidean distance between restored input data and original input data being greater than e, a number of iterations is increased, and the model is retrained. In response to the training time of the model being longer than t, that is, in response to the error reaching a range in an early iteration, the number of iterations is decreased, and the model is retrained.

At step S203, a lowest-layer feature vector is extracted and represented by featuresₗ. The cluster analysis is performed on featuresₗ.

K-means method is selected for clustering. A number of cluster centers is set as k, an initial value is set as k=1, and a Silhouette value is calculated and represented by Silₖ^{h}. The Silhouette value Silₖ^{h} is calculated by continuously letting k=k+1. When k=h, the cycle exits. A maximum Silhouette value Silₖ^{h} and k are obtained, where k represents a number of typical scenarios. In response to the maximum Silhouette value Silₖ^{h} being smaller than 0.85, the number of neurons is reset in response to hₗ<hₗ₋₁, and the model is retrained in response to hₗ=hₗ₊₁; otherwise, the number of hidden layers is reset by letting l=l+1, and the model is retrained.

At step S204, k types of centers of scenarios are found and decoded to restore centers of the original data of the typical scenarios and to restore all of the original data \hat{X}ₙ.

A Euclidean distance between the matrix Xₙ^{m} and \hat{X}ₙ is calculated. The Euclidean distance is represented by Φ_{d}. The above model and results are accepted in response to Φ_{d}≤ε.

If Φ_{d}>ε

If l>1, return to l=l−1, and retrain the model;

Otherwise, return to h=h−1 and retrain the model.

At step S205, a desired result is obtained, and the cycle ends.

At step S3, a model topology and a learned weight matrix are extracted, and the correlation of the variables is analyzed as needed.

An optimum value of k, that is, the number of typical scenarios, in S2 is extracted. An original number of centers of corresponding scenarios is extracted.

In order to make objectives, technical solutions, and advantages of embodiments of the present disclosure clearer, the technical solutions according to embodiments of the present disclosure will be described clearly and completely in combination with the accompanying drawings according to embodiments of the present disclosure. Obviously, the described embodiments are parts of embodiments of the present disclosure, not all of the embodiments of the present disclosure. Normally, components of embodiments of the present disclosure described by and illustrated in the accompanying drawings herein may be arranged and designed in various configurations. Therefore, the following detailed description of embodiments of the present disclosure provided in the accompanying drawings is not intended to limit the scope of the present disclosure, but merely represents selected embodiments of the present disclosure. Based on embodiments of the present disclosure, all other embodiments obtained by a person skilled in the art without creative work shall fall within the scope of the present disclosure.

The following describes the present disclosure in detail with reference to the drawings and using an example IEEE-14 node system.

Initially selected inputs are, as illustrated in Table 1, a total of 30,000 pieces of sample data, each with 53 feature vectors and represented by X₅₃³⁰⁰⁰⁰.

TABLE 1
Input data

| Feature | | | |
|---|---|---|---|
| vector/ | | | |
| Group No. | a(1, 2, 3 . . . 10000) | b(1, 2, 3 . . . 10000) | c(1, 2, 3 . . . 10000) |
| Ua₁ | −3.7, −3.8, −3.7 . . . −3.6 | −5.0, −4.9, −5.0 . . . −5.0 | −5.9, −6.0, −5.9 . . . −6.0 |
| . . . | . . . | . . . | . . . |
| Ua₁₄ | −12.1, −12.3, | −16.0, −16.0, −16.0 . . . −16.0 | −18.8, −18.9, |
| | −12.5 . . . −12.2 | | −19.2 . . . −19.0 |
| Um₁ | 1.06, 1.06, 1.06 . . . 1.06 | 1.06, 1.06, 1.06 . . . 1.06 | 1.06, 1.06, 1.06 . . . 1.06 |
| . . . | . . . | . . . | . . . |
| Um₁₄ | 1.04, 1.04, 1.04 . . . 1.04 | 1.04, 1.04, 1.04 . . . 1.04 | 1.04, 1.04, 1.04 . . . 1.04 |
| Pdₗ | 17.1, 16.6, 17.3 . . . 17.8 | 21.7, 21.7, 21.7 . . . 21.7 | 25.5, 24.9, 25.6 . . . 25.8 |
| . . . | . . . | . . . | . . . |
| Pd₁₄ | 11.6, 11.2, 11.7 . . . 11.5 | 14.9, 14.9, 14.9 . . . 14.9 | 17.5, 17.3, 17.2 . . . 16.9 |
| Pg₁ | 175.8, 173.2, | 232.4, 232.4, | 275.1, 279.8, |
| | 179.4 . . . 180.2 | 232.4 . . . 232.4 | 283.5 . . . 277.5 |
| . . . | . . . | . . . | . . . |
| Pg₅ | 30.3, 30.8, 31.1 . . . 31.8 | 40, 40, 40 . . . 40 | 47.9, 48.1, 46.8 . . . 47.9 |
| Qg₁ | -7.9, −7.4, −8.8 . . . −7.6 | −16.5, −16.5, −16.5 . . . −16.5 | −22.7, −22.1, |
| | | | −21.8 . . . −21.9 |
| . . . | . . . | . . . | . . . |
| Qg₅ | 15.5, 15.6, 15.2 . . . 14.9 | 17.6, 17.6, 17.6 . . . 17.6 | 19.4, 18.7, 19.6 . . . 19.3 |

1. Groups a, b and c respectively represent data obtained from the IEEE14-node system at three different load levels and determined as input sets. X₅₃³⁰⁰⁰⁰ is used as inputs to perform the operation in 2);

2. Model training is carried out: a maximum number of iterations is set to 1,000, α=0.01, and η=4. Initial values such as hₗ=2 and l=1 are set and repeated cyclically according to the method in 2) until an optimum result is found out.

3. The model topology and the learned weight matrix are extracted to analyze the correlation of variables as needed. The optimum value of k, that is, the number of typical scenarios, and original data of centers of corresponding scenarios in 2) is extracted.

The calculated Silhouette values are illustrated in the following table.

TABLE 2
Calculated values of Silhouette values

| | k | | | |
|---|---|---|---|---|
| h | 2 | 3 | 4 | 5 |
| 2 | 0.78 | 0.98 | 0.86 | 0.73 |
| 3 | 0.77 | 0.97 | 0.84 | 0.72 |
| 4 | 0.80 | 0.96 | 0.83 | 0.70 |
| 5 | 0.73 | 0.96 | 0.81 | 0.67 |
| 6 | 0.76 | 0.96 | 0.80 | 0.67 |
| 7 | 0.76 | 0.97 | 0.82 | 0.68 |
| 8 | 0.74 | 0.96 | 0.81 | 0.67 |

It may be seen from Table 2 that when the number of typical scenarios is three, the maximum calculated Silhouette value is about 0.96. It is concluded that an optimal clustering level should be divided into three types when the input data is being trained. The clustering results are in line with the expected three scenarios classified according to the load level, and have extremely significant features.

At the same time, when the number of training scenarios is unchanged, the clustering time and the dimensionality of feature vectors participating in the clustering are almost linear, that is, the higher the dimensionality of the feature vector, the longer the clustering time. It reflects the classification of typical scenarios using the sparse autoencoder. On the premise that the clustering effect is almost unchanged, when the dimensionality reduction is performed on the feature vectors, the time consumed is greatly shortened, meeting the rapidity required by the power system in calculations. In addition, it may be seen from the results that if the scale, that is, the number of nodes, of the power grid is greater and the dimensionality of the feature vectors is higher, reducing the dimensionality of the feature vectors through the sparse autoencoder will have a more significant effect on improving the clustering effect and will facilitate the actual calculation.

The above content is only to illustrate technical concepts of the present disclosure, and cannot be used to limit the scope of the present disclosure. Any changes made on the basis of the technical solutions in accordance with the technical concepts proposed by the present disclosure shall fall into the scope defined by claims of the present disclosure.

What is claimed is:

1. A method for performing clustering on operation modes of a power system based on a sparse autoencoder, comprising:
obtaining related data of the power system;
setting a training parameter, a number of hidden layers, and a number of neurons;
training an autoencoder model using the related data and extracting a topological structure and a weight matrix from the model;
performing cluster analysis to obtain a number of typical scenarios; and
performing decoding to obtain original data at centers of respective scenarios.

2. The method of claim 1, wherein the related data forms an input matrix Xₙ^{m} having n rows and m columns, n being a vector, and m being a number of samples.

3. The method of claim 1, wherein the related data comprises a voltage of each node in the power system, a voltage amplitude, data of active power and reactive power of an electric generator at each node, and time-series load data of the power system within research time.

4. The method of claim 1, wherein said setting the training parameter, the number of hidden layers, and the number of neurons comprises:
setting related parameters α, η, and a maximum number of iterations as initialization training parameters, α being a coefficient of L2 regularization, and η being a coefficient of sparse regularization; setting l=1, l being the number of hidden layers; and setting hₗ=2, hₗ being the number of neurons of an l-th hidden layer, which is a dimension of a final feature vector.

5. The method of claim 1, wherein said training the autoencoder model using the related data comprises steps of:
S201 of determining an input matrix Xₙ^{m} having n rows and m columns formed by the related data as an input;
S202 of inputting an acceptable error e and a training time t for visual training, and observing the error and a training process;
S203 of extracting a lowest-layer feature vector featuresₗ, and performing the cluster analysis on featuresₗ;
S204 of finding k types of centers of scenarios, and decoding the k types of centers of scenarios to restore centers of the original data of the typical scenarios and restore all of the original data \hat{X}ₙ; and
S205 of obtaining a desired result, and ending a cycle.

6. The method of claim 5, wherein in step S202, in response to a Euclidean distance between restored input data and original input data being greater than e, a number of iterations is increased, and the model is retrained; and in response to training time of the model being longer than t, that is, in response to the error reaching a range in an early iteration, the number of iterations is decreased, and the model is retrained.

7. The method of claim 5, wherein in step S203, K-means method is selected for the clustering, a number of cluster centers is set as k, an initial value is set as k=1, and a Silhouette value Silₖ^{h} is calculated; the Silhouette value Silₖ^{h} is calculated by taking k=k+1, and in response to k=h, the cycle exits; and a maximum Silhouette value Silₖ^{h} and a number k of the typical scenarios are obtained.

8. The method of claim 7, wherein in response to the maximum Silhouette value Silₖ^{h} being smaller than 0.85, the number of neurons is reset when hₗ<hₗ₋₁, and the model is retrained when hₗ=hₗ₊₁; otherwise, the number of hidden layers is reset as l=l+1, and the model is retrained.

9. The method of claim 5, wherein in step S204, a Euclidean distance Φ_{d} between the matrix Xₙ^{m} and \hat{X}ₙ is calculated, and an acceptance is made in response to Φ_{d}≤ε.

10. The method of claim 5, wherein in step S204, in response to Φ_{d}>ε and l>1, the model is retrained by returning to l=l−1; otherwise, the model is retrained by returning to h=h−1.

11. The method of claim 2, wherein the related data comprises a voltage of each node in the power system, a voltage amplitude, data of active power and reactive power of an electric generator at each node, and time-series load data of the power system within research time.
